(19) United States
(12) Patent Application Publication
(10) Pub. No.: US 2013/0089370 A1
(43) Pub. Date: Apr. 11, 2013

(54) COOLING DEVICE AND METHOD FOR MANUFACTURING A COOLING DEVICE FOR A VEHICLE

(71) Applicant: Behr GmbH & Co. KG, Stuttgart (DE)

(72) Inventor: Reinhard HEINE, Leutenbach (DE)

(73) Assignee: Behr GmbH & Co. KG, Stuttgart (DE)

(21) Appl. No.: 13/649,650

(22) Filed: Oct. 11, 2012

(30) Foreign Application Priority Data
Oct. 11, 2011 (DE) DE102011084307.8

(51) Int. Cl. F16B 17/00; B23P 11/00

(52) U.S. Cl. 403/28; 29/890.035

(57) ABSTRACT

A cooling device for a vehicle is provided that includes a first air cooler that has a first element of a sliding seat tenon-and-mortise joint and a first element of a latching joint. The cooling device has a second air cooler connected to the first air cooler that has a second element of the sliding seat tenon-and-mortise joint and a second element of the latching joint, the elements of the latching joint and the elements of the sliding seat tenon-and mortise joint being designed in such a way that a form-locked connection between the two air coolers may be produced by the latching joint and the sliding seat tenon-and-mortise joint.

This nonprovisional application claims priority under 35 U.S.C. §119(a) to German Patent Application No. DE 10 2011 084 307.8, which was filed in Germany on Oct. 11, 2011, and which is herein incorporated by reference.

### BACKGROUND OF THE INVENTION

1. Field of the Invention

The present invention relates to a cooling device and a method for manufacturing a cooling device, in particular for a vehicle, which may be used, for example, as a cooling module.

2. Description of the Background Art

A cooling device, also referred to as a cooling module, for a vehicle having an internal combustion engine may have a charge air/air cooler and a coolant/air cooler, which may be connected to the cooling device. If different materials are used for the cooler, hereinafter also referred to simply as an air cooler, when the cooler uses air as the fluid involved in the heat exchange, and if fixing elements are used to connect the cooler, it is necessary to take into account the tolerance compensation and variable thermal expansion between the materials. Care must be taken to ensure that the attachment has as little clearance as possible.

### SUMMARY OF THE INVENTION

It is therefore an object of the present invention to provide an improved cooling device for a vehicle and an improved method for manufacturing a cooling device for a vehicle.

The approach according to an embodiment of the invention may be used for a cooling device which comprises two air coolers. The two air coolers are connected in a form-locked manner via two joints. The one joint may be designed as a sliding seat tenon-and-mortise joint, and the other joint may be designed as a latching joint. Common to both joints is the fact that they comprise two elements, each element being assigned to one joint on one of the air coolers and the other element being assigned to the other air cooler. The one element of the sliding seat tenon-and-mortise joint is designed to engage with the other element of the sliding seat tenon-and-mortise joint, which serves as a receptacle for the one element of the sliding seat tenon-and-mortise joint. In the case of the latching joint, the one element of the latching joint is likewise designed to engage with the other element of the latching joint, which serves as a receptacle. To manufacture the cooling device, the sliding seat tenon-and-mortise joint is produced first, followed by the two air coolers, to move this joint in such a way that the latching joint closes and the two air coolers thus join together to form a cooling device.

Complex joints using additional parts may be advantageously dispensed with and, as a result, complex assembly may also be avoided. In a design made entirely of plastic parts, the corrosion protection that would otherwise have been needed for metal holders is eliminated, since no corrosion problems arise, due to the plastic parts. The approach according to the invention permits easy assembly or disassembly. A charge air/air cooler may be attached to a coolant/air cooler without any additional fixing elements such as holders, bolts, screws or rivets. This may ultimately result in a cost-effective attachment of the charge air/air cooler to the coolant/air cooler. It is possible to dispense with the use of different materials for the air coolers and the fixing elements.

The tolerance compensation and the variable thermal expansion of the coolers may be more easily taken into account. Care may thus be taken to ensure that the attachment has as little clearance as possible.

An embodiment of the present invention provides a cooling device for a vehicle which includes a first air cooler having a first element of a sliding seat tenon-and-mortise joint and a first element of a latching joint; and a second air cooler having a second element of the sliding seat tenon-and-mortise joint and a second element of the latching joint, the elements of the latching joint and the elements of the sliding seat tenon-and-mortise joint being designed in such a way that a form-locked connection between the two air coolers may be established by the latching joint and the sliding seat tenon-and-mortise joint.

The vehicle may be, for example, an automobile or a truck. The vehicle may have an internal combustion engine. Air and coolant may be cooled with the aid of the cooling device for the vehicle. The cooling device may comprise two air coolers. The two air coolers may be designed as separate components. The air coolers may be used as heat exchangers. The air coolers may use ambient air, i.e., they are air-cooled coolers. One air cooler may cool the charge air, in which case it is referred to as a charge air/air cooler, or it may cool a coolant, in which case it is referred to as a coolant/air cooler. A sliding seat tenon-and-mortise joint may be generally understood to be a joint comprising two elements in which the one element is designed, for example, as a cuboid projection which may be inserted into a receptacle of the other element. The other element acting as the receptacle is designed as a fit for the cuboid projection, the fixed seat being designed as a sliding seat in the assembled state, i.e., the two elements may join together by sliding into each other. A latching joint may generally be understood to be a connection between two elements which uses the elasticity of the material to permit the two elements of the connection to join together in a form-locked manner. The one element of the latching joint may be implemented as the joining part, and the other element may be implemented as a receptacle for the joining part. The joining part is elastically deformable and may detachably engage with the receptacle for the joining part. According to one specific embodiment of the present invention, one of the elements of the sliding seat tenon-and-mortise joint may be a tenon having one chamfer on each side. The other element of the sliding seat tenon-and-mortise joint may be designed as a sliding seat for the tenon. A tenon in this case may be understood to be a cuboid projection of the one air cooler. A chamfer is generally understood to be a sloped surface, in this case of the tenon. This approach has the advantage that a certain amount of assembly clearance is obtained for joining.

At least one of the two air coolers may be designed in such a way that a contact surface for holding the tenon in place against the sliding seat is produced in the form-locked connection between the two air coolers. A contact surface may generally be understood to be the contact between two bodies. The contact surface provides the advantage that the tenon of the sliding seat tenon-and-mortise joint is held in place in the receptacle and, during the joining process, the fit of a sliding seat may become a press fit in the assembled state.

According to an embodiment of the present invention, one of the elements of the latching joint may be a latching hook. The other element of the latching joint may be designed as a receptacle for the latching hook. The latching hook may be a specific shaped area of a joining part. This specific embodiment is advantageous because a form-locked connection may be achieved without any additional components, and the connection may also be easily released.

The latching hook may be designed to be subjected to compressive loading when the form-locked connection is established. Alternatively, the latching hook may be designed to be subjected to tensile loading. The design according to the present invention may thus be adapted to different basic conditions of the material and the installation location.

The sliding seat tenon-and-mortise joint and the latching hook joint may be disposed on two opposite sides of the cooling device. This makes it possible to minimize the mechanical load on the two joints, while ensuring an optimum hold.

According to an embodiment of the present invention, the first air cooler may be designed as a coolant/air cooler and the second air cooler may be designed as a charge air/air cooler. This provides the advantage of combining different air-cooled coolers to form one cooling device.

The two air coolers may furthermore be made of plastic. This may simplify corrosion protection or make it completely obsolete.

In the first air cooler, the first element of the sliding seat tenon-and-mortise joint and the first element of the latching joint may be permanently integrated. In the second air cooler, the second element of the sliding seat tenon-and-mortise joint and the second element of the latching joint may be permanently integrated. Additional components may be eliminated thereby. This makes it possible to implement a cost-effective cooling device.

The invention furthermore includes a method for manufacturing a cooling device for a vehicle, which includes the steps of providing a first air cooler which has a first element of a sliding seat tenon-and-mortise joint and a first element of a latching joint; providing a second air cooler which has a second element of the sliding seat tenon-and-mortise joint and a second element of the latching joint, the elements of the latching joint and the elements of the sliding seat tenon-and-mortise joint being designed in such a way that a form-locked connection between the two air coolers may be established by the latching joint and the sliding seat tenon-and-mortise joint; moving the two air coolers for the purpose of pushing the two elements of the sliding seat tenon-and-mortise joint into each other at an angle, a rotation axis being produced within the sliding seat tenon-and-mortise joint; and folding up the two air coolers around the rotation axis in the sliding seat tenon-and-mortise joint for the purpose of joining the two elements of the latching joint to form the latching joint in order to establish a form-locked connection between the two air coolers.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a representation of a charge air cooler;

FIG. 2 shows a representation of a rear view of the charge air cooler illustrated in FIG. 1;

FIG. 3 shows a representation of a cooling device according to an embodiment of the invention in the assembled state;

FIG. 4 shows a representation of the cooling device according to an embodiment of the invention illustrated in FIG. 3, in the not-yet-assembled state;

FIGS. 5 through 12 show detailed views of the cooling device according to the invention illustrated in FIG. 3;

FIG. 13 shows a representation of a method step for manufacturing a cooling device according to the invention illustrated in FIG. 3;

FIG. 14 shows a representation of another method step for manufacturing a cooling device according to the invention;

FIGS. 15 and 16 show detailed views of the latching joint in the method steps illustrated in FIGS. 13 and 14 for manufacturing a cooling device according to the invention;

FIG. 17 shows a representation of another cooling device according to the invention in the assembled state;

FIG. 18 shows a representation of the cooling device according to the invention illustrated in FIG. 17, in the disassembled state;

FIGS. 19 through 26 show detailed views of the cooling device according to the invention illustrated in FIG. 17;

FIG. 27 shows a representation of a method step for manufacturing a cooling device according to the invention illustrated in FIG. 17;

FIG. 28 shows a detailed view of the sliding seat tenon-and-mortise joint in the method step illustrated in FIG. 27 for manufacturing a cooling device according to the invention;

FIG. 29 shows a detailed view of the latching joint in the method step illustrated in FIG. 27 for manufacturing a cooling device according to the invention;

FIG. 30 shows a detailed view of the sliding seat tenon-and-mortise joint in the method step illustrated in FIG. 27 for manufacturing a cooling device according to the invention; and

FIG. 31 shows a detailed view of the latching joint in the method step illustrated in FIG. 27 for manufacturing a cooling device according to the invention.

### DETAILED DESCRIPTION

In the following description of the preferred exemplary embodiments of the present invention, identical or similar reference numerals are used for the elements illustrated in the different drawings and having a similar function, these elements not being described repeatedly.

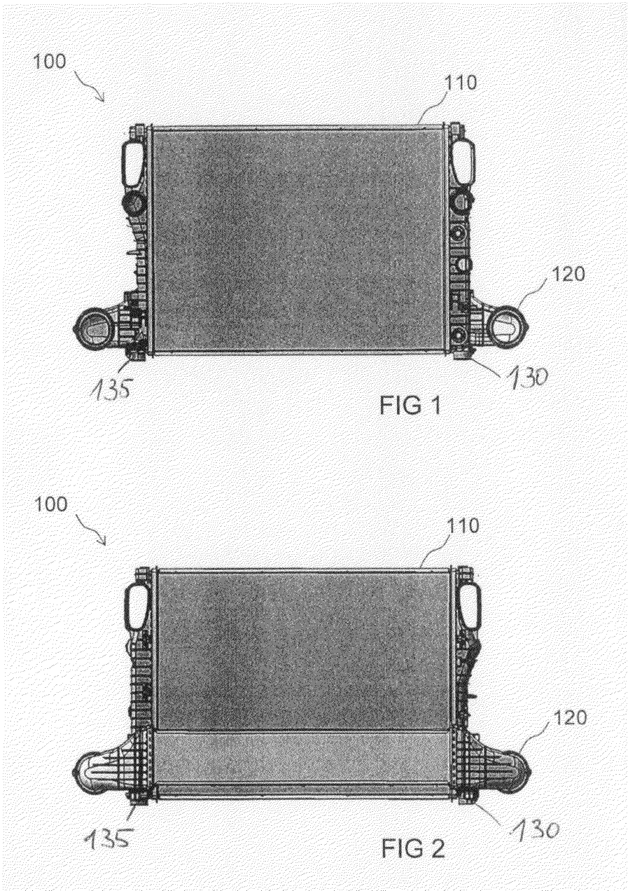

FIG. 1 shows cooling device 100. Cooling device 100 has a coolant/air cooler 110 and a charge air/air cooler 120. A module bearing 130 is connected on one side of coolant/air cooler 110. Another module bearing 135 is connected on the side of coolant/air cooler 110 opposite module bearing 130. Charge air/air cooler 120 is fixed directly to module bearings 130, 135.

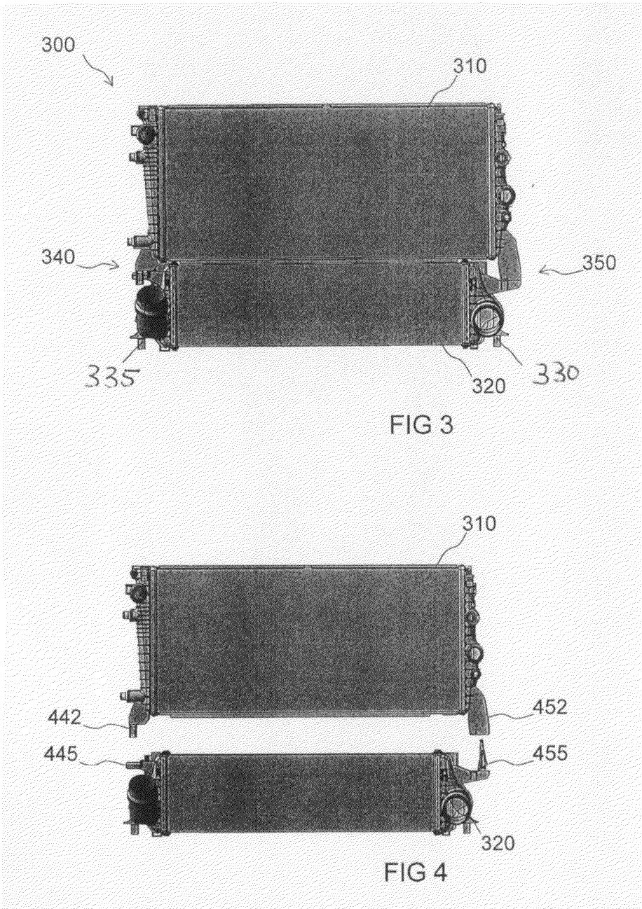

FIG. 2 shows a rear view of cooling device 100 illustrated in FIG. 1. Cooling device 100 is shown along with coolant/air cooler 110, charge air/air cooler 120 and module bearings 130, 135.

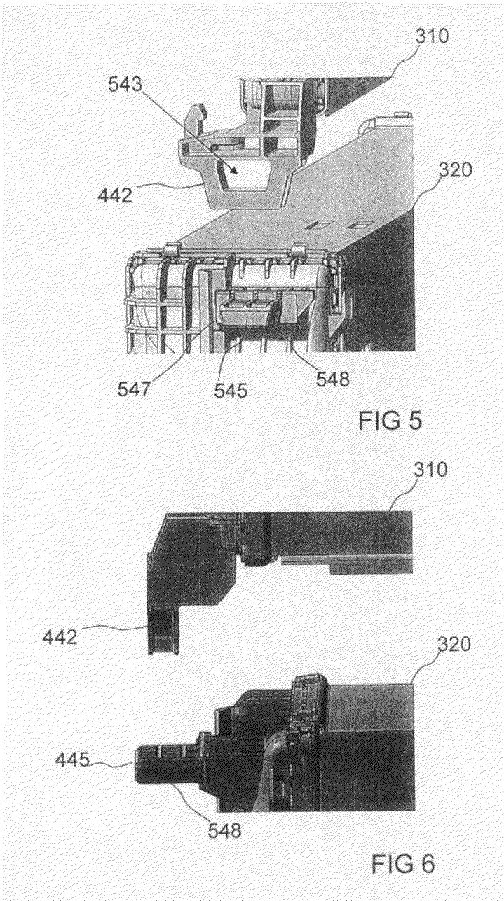

FIG. 3 shows a representation of a cooling device 300 according to one exemplary embodiment of the present invention. Cooling device 300 has a coolant/air cooler 310 and a charge air/air cooler 320. Coolant/air cooler 310 is connected to charge air/air cooler 320 in a form-locked manner. The air coolers each have a heat transfer element. The connection between the two air coolers 310, 320 is established by a sliding seat tenon-and-mortise joint 340 and a latching joint 350. A module bearing 330 is connected on one side of coolant/air cooler 310. Another module bearing 335 is connected on the side of coolant/air cooler 310 opposite module bearing 330. Module bearings 330, 335 are each disposed on a lateral end of a collector box. Sliding seat tenon-and-mortise joint 340 is disposed on the side of air coolers 310, 320 outside the heat transfer element. Latching joint 350 is disposed on the side of air coolers 310, 320 outside the heat transfer element and opposite the sliding seat tenon-and-mortise joint.

Cooling device 300 is illustrated in the assembled state.

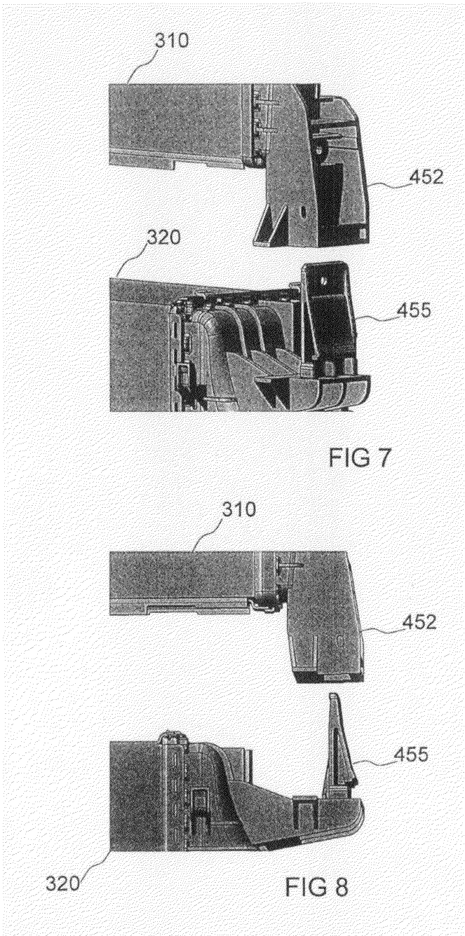

FIG. 4 shows cooling device 300 illustrated in FIG. 3 according to one exemplary embodiment of the present invention, in the disassembled state. The two air coolers 310, 320 are disposed at a distance from each other. Sliding seat tenon-and-mortise joint 340 is disengaged. Sliding seat tenon-and-mortise joint 340 comprises two elements. The one element of sliding seat tenon-and-mortise joint 340 is disposed on the side of charge air/air cooler 320 and designed as a tenon 445. The other element of sliding seat tenon-and-mortise joint 340 is disposed on the side of coolant/air cooler 310 and designed as a sliding seat 442 for tenon 445. Latching joint 350 comprises two elements. The one element of latching joint 350 is disposed on the side of charge air/air cooler 320 and designed as a latching hook 455. The other element of latching joint 350 is positioned on the side of coolant/air cooler 310 and designed as a latching hook receptacle 452 for latching hook 455.

On one side—the left side in FIG. 4—charge air/air cooler 310 is accommodated in a sliding seat 442—also referred to as a movable bearing—in a form-locked manner, positioned transversely to the direction of travel. Charge air/air cooler 320 is held lightly in place on this side in the vertical direction. More specifically, the sliding seat tenon-and-mortise joint is held in place. On the right side in FIG. 4, charge air/air cooler 320 is accommodated in a form-locked manner in the direction of travel and transversely to the direction of travel. In the vertical direction, charge air/air cooler 320 is fixed in place with the aid of a latching hook 455.

In this exemplary embodiment, fixing elements 442, 445, 452, 455 are integrated into the plastic boxes of coolers 310, 320.

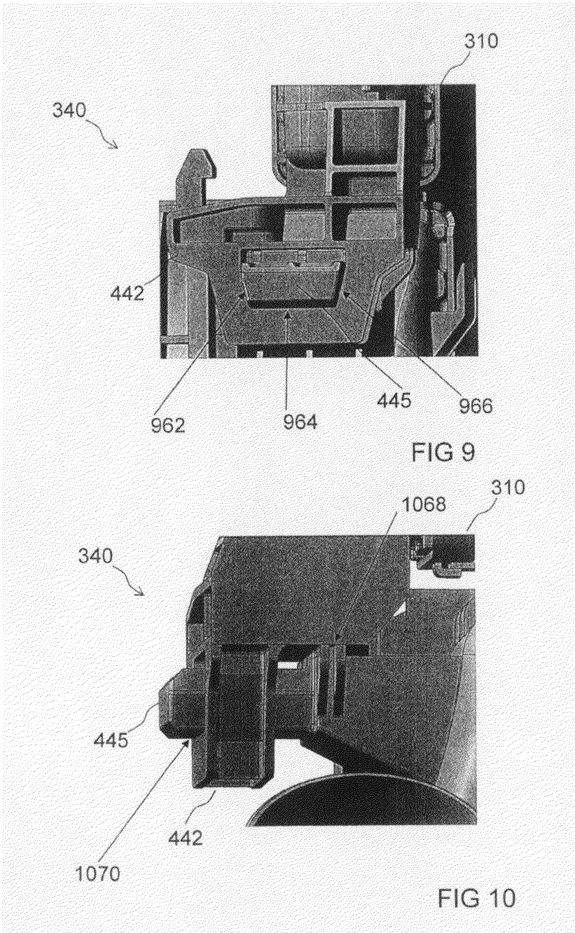

FIG. 5 shows a detailed view of the sliding seat tenon-and-mortise joint of cooling device 300 illustrated in FIG. 3 according to one exemplary embodiment of the present invention, in the disassembled state. The two air coolers 310, 320 are disposed at a distance from each other. Tenon 545 has a rectangular shape, including two side chamfers 547, 548 on opposite sides. A sliding seat receptacle 543 in sliding seat 442 is designed in such a way that a form-locked accommodation of tenon 545 is permitted. Sliding seat receptacle 543 is implemented as a through-hole in sliding seat 442.

Due to side chamfers 547, 548 on rectangular tenon 545, a certain amount of assembly clearance is obtained during joining.

FIG. 6 shows a detailed side view of the sliding seat tenon-and-mortise joint of cooling device 300 illustrated in FIG. 3 according to one exemplary embodiment of the present invention, in the disassembled state. Side chamfer 548 on tenon 445 is illustrated.

FIG. 7 shows a detailed view of the latching joint of cooling device 300 illustrated in FIG. 3 according to one exemplary embodiment of the present invention, in the disassembled state. The two air coolers 310, 320 are disposed at a distance from each other. Latching hook 455 and latching hook receptacle 452 are illustrated.

Latching hook 455 on charge air/air cooler 320, which is positioned on the right in the direction of travel, is designed to be subjected to compressive loading.

FIG. 8 shows another detailed side view of the latching joint illustrated in FIG. 7, comprising latching hook 455 and latching hook receptacle 452, according to one exemplary embodiment of the present invention, in the disassembled state.

FIG. 9 shows a detailed view of sliding seat tenon-and-mortise joint 340 illustrated in FIG. 3 according to one exemplary embodiment of the present invention, in the assembled state. Sliding seat 442 and tenon 445 are designed in such a way that contact surfaces 962, 964, 966 are produced between the two elements 442, 445 of sliding seat tenon-and-mortise joint 340 in the assembled state. Contact surfaces 962, 964, 966 are produced between the outer walls of tenon 445 and the inner walls of sliding seat receptacle 442. The surface where two body surfaces touch each other is referred to here as a contact surface.

FIG. 10 shows a detailed view of sliding seat tenon-and-mortise joint 340 illustrated in FIG. 3 according to one exemplary embodiment of the present invention, in the assembled state. Sliding seat 442 a tenon 445 are designed in such a way that a sliding seat fit 1070 is produced between the two elements 442, 445 for assembly. In the assembled state, a contact surface 1068 is produced which is held lightly in place in the assembled state.

When flipped up, the edges of tenon 445 and receptacle 442 lie on top of each other on coolant/air cooler 310. Tenon 445 is held lightly in place in the vertical direction by another contact surface 1068.

FIG. 11 shows a detailed view of latching joint 350 illustrated in FIG. 3 according to one exemplary embodiment of the present invention, in the assembled state. A lower contact surface 1182 and side contact surfaces 1184, 1186 are produced between latching hook 455 and latching hook receptacle 452.

FIG. 12 shows a detailed, sectional view of latching joint 350 illustrated in FIG. 3 according to one exemplary embodiment of the present invention, in the assembled state. Latching hook 455 engages with latching hook receptacle 452. Screw hole 1256 is provided in latching hook 455.

Latching hook 455 is subjected to compressive loading. Latching hook 455 is fixed circumferentially in a form-locked manner with the aid of contact surfaces 1182, 1184, 1186. As a fallback solution, charge air/air cooler 320 may be screwed onto coolant/air cooler 310 with the aid of screw hole 1256.

On the right side in FIG. 12, charge air/air cooler 320 is accommodated in a form-locked manner in the direction of travel and transversely to the direction of travel. In the vertical direction, the charge air/air cooler is fixed in place with the aid of a latching hook 455. Latching hook 455 is subjected to compressive loading. In another exemplary embodiment, which is not illustrated herein, latching hook 455 may also be subjected to tensile loading.

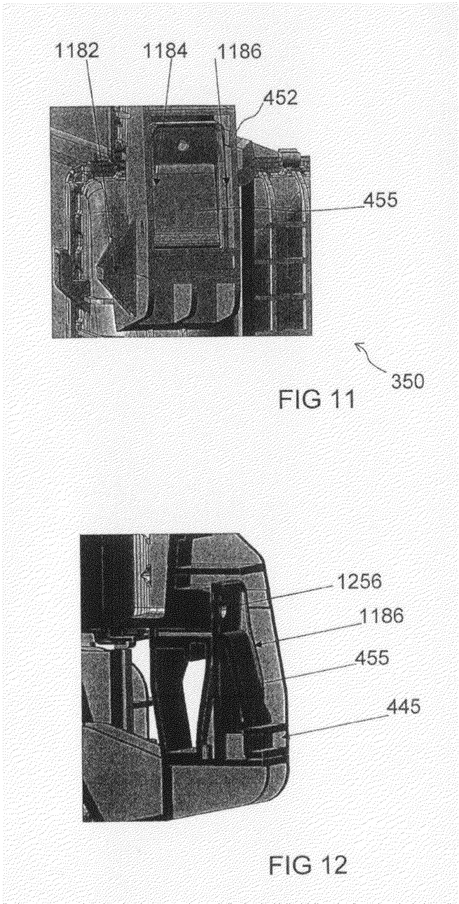

FIG. 13 shows cooling device 300 illustrated in FIG. 3 according to one exemplary embodiment of the present invention, in the disassembled state. The two air coolers 310, 320 are disposed at a distance from each other. sliding seat tenon-and-mortise joint 340 and latching joint 350 are disengaged.

In a step for manufacturing cooling device 300, the charge air/air cooler is inserted into sliding seat 442 on coolant/air cooler 310 on the side of sliding seat tenon-and-mortise joint 340 at an angle in relation to coolant/air cooler 310, in the direction of movement of sliding seat tenon-and-mortise joint assembly 1392. Due to the side chamfers on rectangular tenon 445, a certain amount of assembly clearance is obtained.

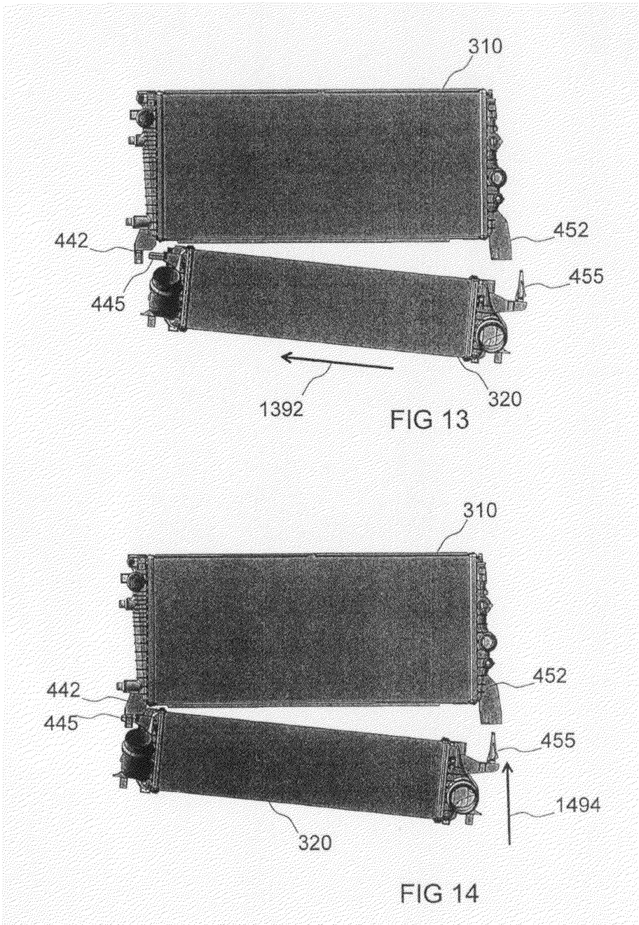

FIG. 14 shows cooling device 300 illustrated in FIG. 13 according to one exemplary embodiment of the present invention, in the state during assembly. Tenon 445 has already been inserted into sliding seat 442. Latching joint 350 is disengaged.

In this position, the charge air/air cooler may be flipped up.

Illustrated on the left side in FIG. 14, charge air/air cooler 320 is accommodated in a form-locked manner in a sliding seat 442 (movable bearing transverse to the direction of travel). Charge air/air cooler 320 is held lightly in place on this side in the vertical direction. On the right side, charge air/air cooler 320 is accommodated in a form-locked manner in the direction of travel and transversely to the direction of travel. In the vertical direction, charge air/air cooler 320 is fixed in place with the aid of a latching hook 455.

On the left in FIG. 14, charge air/air cooler 320 is inserted into receptacle 342 on coolant/air cooler 310 and, on the right side in FIG. 14, it is flipped up in the direction of movement of latching joint assembly 1494 and fixed to latching hook 455.

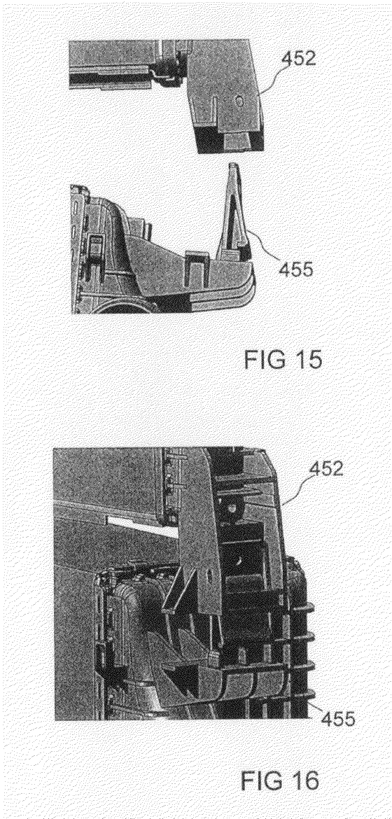

FIG. 15 shows latching joint 350 of cooling device 300 illustrated in FIG. 3 according to one exemplary embodiment of the present invention, in the disassembled state. Latching joint 350 is disengaged.

FIG. 16 shows latching joint 350 of cooling device 300 illustrated in FIG. 3 according to one exemplary embodiment of the present invention, in the half assembled state.

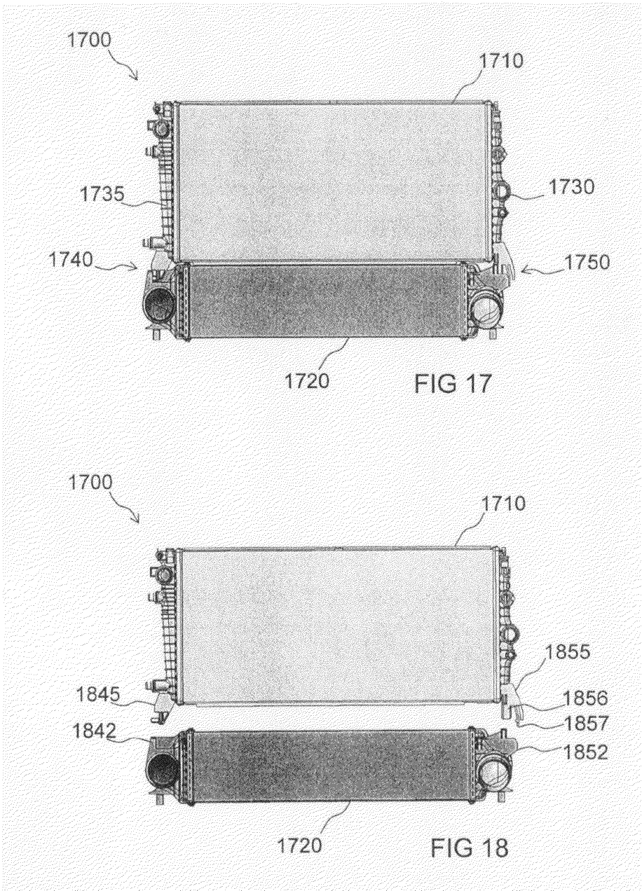

FIG. 17 shows a representation of a cooling device 1700 according to another exemplary embodiment of the present invention. Cooling device 1700 has a coolant/air cooler 1710 and a charge air/air cooler 1720. Coolant/air cooler 1710 is connected to charge air/air cooler 1720 in a form-locked manner. The air coolers each have a heat transfer element. The connection between the two air coolers 1710, 1720 is established by a sliding seat tenon-and-mortise joint 1740 and a latching joint 1750. Sliding seat tenon-and-mortise joint 1740 is disposed on the side of air coolers 1710, 1720 outside the heat transfer element. Latching joint 1750 is disposed on the side of air coolers 1710, 1720 outside the heat transfer element and opposite the sliding seat tenon-and-mortise joint.

Cooling device 1700 is illustrated in the assembled state.

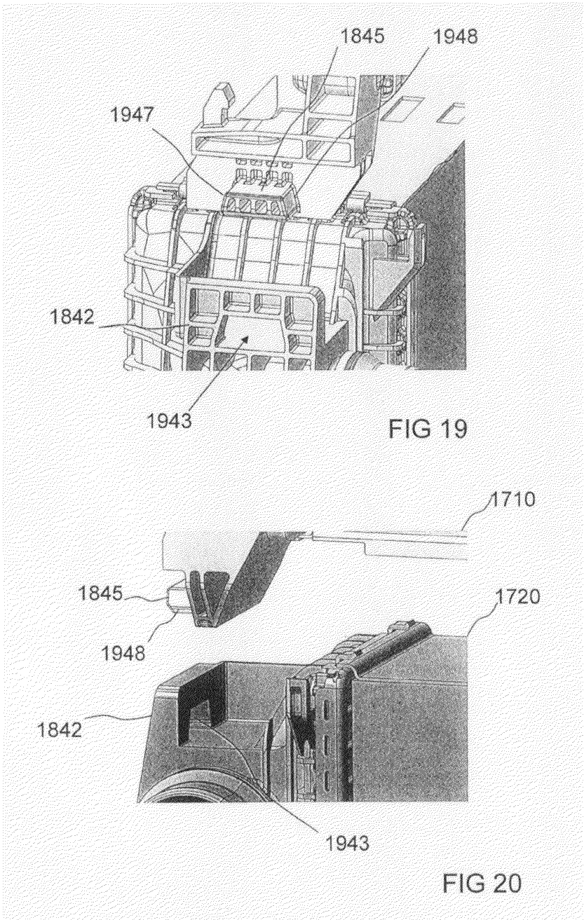

FIG. 18 shows cooling device 1700 illustrated in FIG. 17 according to one exemplary embodiment of the present invention, in the disassembled state. The two air coolers 1710, 1720 are disposed at a distance from each other. Sliding seat tenon-and-mortise joint 1740 is disengaged. Sliding seat tenon-and-mortise joint 1740 comprises two elements. The one element of sliding seat tenon-and-mortise joint 1740 is positioned on the side of coolant/air cooler 1710 and designed as a tenon 1845. The other element of sliding seat tenon-and-mortise joint 1740 is positioned on the side of charge air/air cooler 1720 and designed as a sliding seat 1842 for tenon 1845. Latching joint 1750 comprises two elements. The one element of latching joint 1750 is disposed on the side of coolant/air cooler 1710 and designed as a latching hook 1855. The other element of latching joint 1750 is positioned on the side of charge air/air cooler 1720 and designed as a latching hook receptacle 1852 for latching hook 1855. The latching hook is designed in such a way that a guide projection 1856 and a latching element 1857 are formed.

Charge air/air cooler 1720 is accommodated on one side—the left side in FIG. 18—in a form-locked manner, positioned in a sliding seat 1842. Charge air/air cooler 1720 is held lightly in place on this side in the vertical direction. More specifically, the sliding seat tenon-and-mortise joint is held in place. On the right side in FIG. 18, charge air/air cooler 1720 is accommodated in a form-locked manner in the direction of travel and transversely to the direction of travel. The positioning is accomplished by guide projection 1856 and by correspondingly accommodating the guide projection in latching hook receptacle 1852. In the vertical direction, charge air/air cooler 1720 is fixed in place with the aid of a latching hook 1855.

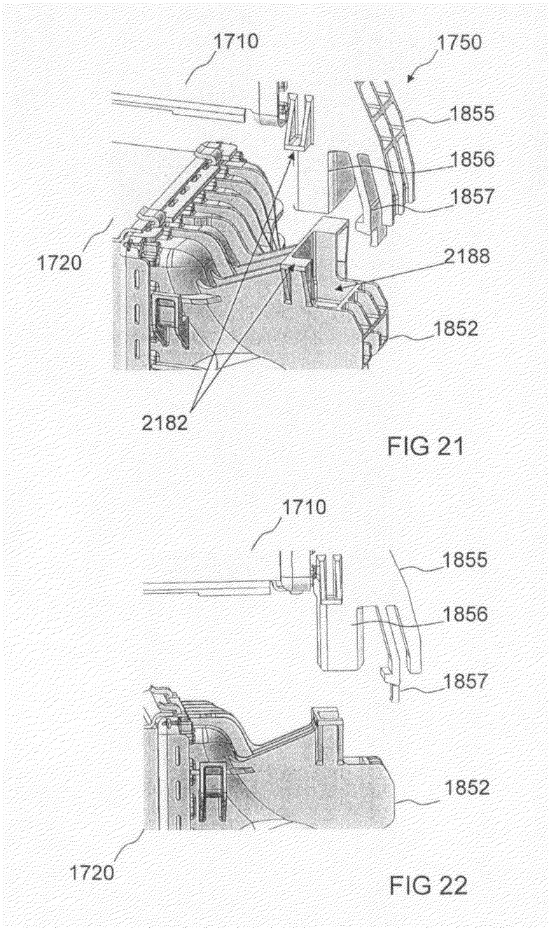

FIG. 19 shows a detailed view of the sliding seat tenon-and-mortise joint of cooling device 1700 illustrated in FIG. 17 according to one exemplary embodiment of the present invention, in the disassembled state. The two air coolers 1710, 1720 are disposed at a distance from each other. Tenon 1845 has a rectangular shape, including two side chamfers 1947, 1948 on opposite sides. A sliding seat receptacle 1943 in sliding seat 1842 is designed in such a way that a form-locked accommodation of tenon 1845 is permitted. Sliding seat receptacle 1943 is implemented as a through-hole in sliding seat 1842.

FIG. 20 shows detailed side view of the sliding seat tenon-and-mortise joint of cooling device 1700 illustrated in FIG. 17 according to one exemplary embodiment of the present invention, in the disassembled state. Side chamfer 1948 on tenon 1845 is illustrated.

FIG. 21 shows a detailed view of the latching joint of cooling device 1700 illustrated in FIG. 17 according to one exemplary embodiment of the present invention, in the disassembled state. The two air coolers 1710, 1720 are disposed at a distance from each other. Latching hook 1855 and latching hook receptacle 1852 are illustrated. In this exemplary embodiment, latching hook 1855 has a guide projection 1856 and a latching element 1857 as features. Latching hook receptacle 1852 is designed in such a way that a recess 2188 permits the form-locked accommodation of guide protection 1856.

Latching hook 1855 on coolant/air cooler 1710, which is positioned on the right in the direction of travel, is designed to be subjected to tensile loading.

FIG. 22 shows another detailed side view of the latching joint illustrated in FIG. 21, comprising latching hook 1855 and latching hook receptacle 1852, according to one exemplary embodiment of the present invention, in the disassembled state.

FIG. 23 shows a detailed view of sliding seat tenon-and-mortise joint 1740 illustrated in FIG. 17 according to one exemplary embodiment of the present invention, in the assembled state. Sliding seat 1842 and tenon 1845 are designed in such a way that contact surfaces 2362, 2364, 2366 are produced between the two elements 1842, 1845 of sliding seat tenon-and-mortise joint 1740 in the assembled state. Contact surfaces 2362, 2364, 2366 are produced between the outer walls of tenon 1845 and the inner walls of sliding seat receptacle 1842. The surface where two body surfaces touch each other is referred to here as a contact surface.

FIG. 24 shows a side view of the detailed view of sliding seat tenon-and-mortise joint 1740 illustrated in FIG. 23 according to one exemplary embodiment of the present invention, in the assembled state. Sliding seat 1842 and tenon 1845 are designed in such a way that a sliding seat fit 2470 is produced between the two elements 1842, 1845 for assembly. In the assembled state, a contact surface 2468 is produced which is held lightly in place in the assembled state.

In the exemplary embodiment illustrated in FIG. 24, sliding seat 2470 is positioned transversely to the direction of travel in the assembled state.

FIG. 25 shows a detailed view of latching joint 1750 illustrated in FIG. 17 according to one exemplary embodiment of the present invention, in the assembled state. A contact surface 2482 illustrated in the horizontal direction in FIG. 25 and a contact surface 2484 illustrated in the vertical direction in FIG. 25 are produced between latching hook 1855 and latching hook receptacle 1852. Contact surface 2484 is also referred to as the side contact surface. Another side contact surface, which is not illustrated in FIG. 25, is produced on the side of guide protection 1856 opposite contact surface 2484. The contact surfaces ensure a secure and accurate positioning for the form-locked connection of the two coolers 1710, 1720.

FIG. 26 shows a detailed, sectional view of latching joint 1750 illustrated in FIG. 17 according to one exemplary embodiment of the present invention, in the assembled state. Latching element 1857 of latching hook 1855 engages with latching hook receptacle 1852.

Latching hook 1855 may be disengaged from below during disassembly. Latching hook 1855 is subjected to tensile loading. In the lower area, latching hook 1855 is fixed circumferentially in place in a form-locked manner in recess 2188 with the aid of contact surfaces 2182, 2184, which are not explicitly illustrated in FIG. 26, and the contact surface located on the side opposite contact surface 2184 on guide projection 1856.

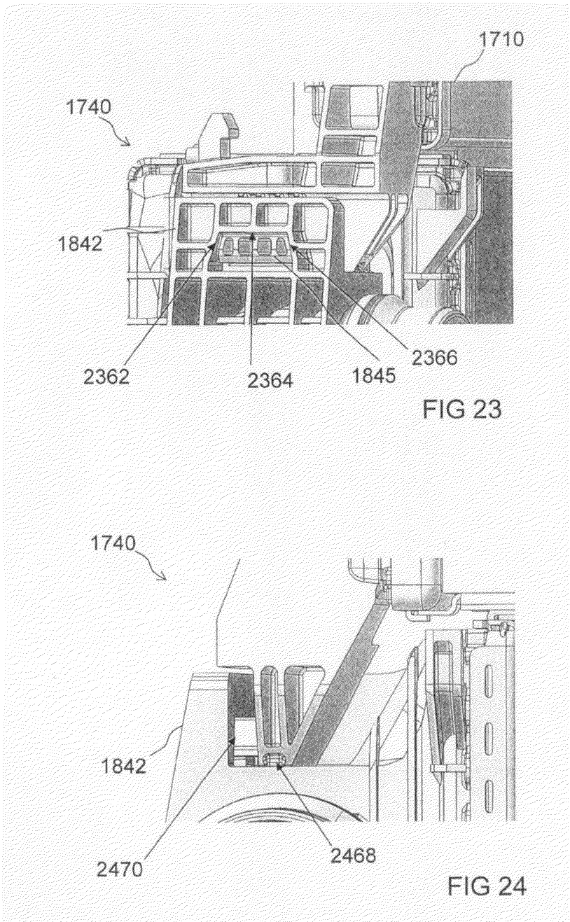

FIG. 27 shows cooling device 1700 illustrated in FIG. 17 according to one exemplary embodiment of the present invention, in the disassembled state. The two air coolers 1710, 1720 are disposed at a distance from each other. Sliding seat tenon-and-mortise joint 1740 and latching joint 1750 are disengaged.

In a step for manufacturing cooling device 1700, the charge air/air cooler is inserted into tenon 1845 on coolant/air cooler 1710 on the side of sliding seat tenon-and-mortise joint 1740 at an angle in relation to coolant/air cooler 1710. In FIG. 27, the direction of movement of sliding seat tenon-and-mortise joint assembly 2792, i.e., the direction of movement of charge air/air cooler 1720, is shown from left to right. Due to the side chamfers on rectangular tenon 1845, a certain amount of assembly clearance is obtained.

The exemplary embodiment of the present invention illustrated in FIG. 27 may be disassembled in the vehicle. The exemplary embodiment requires little clearance.

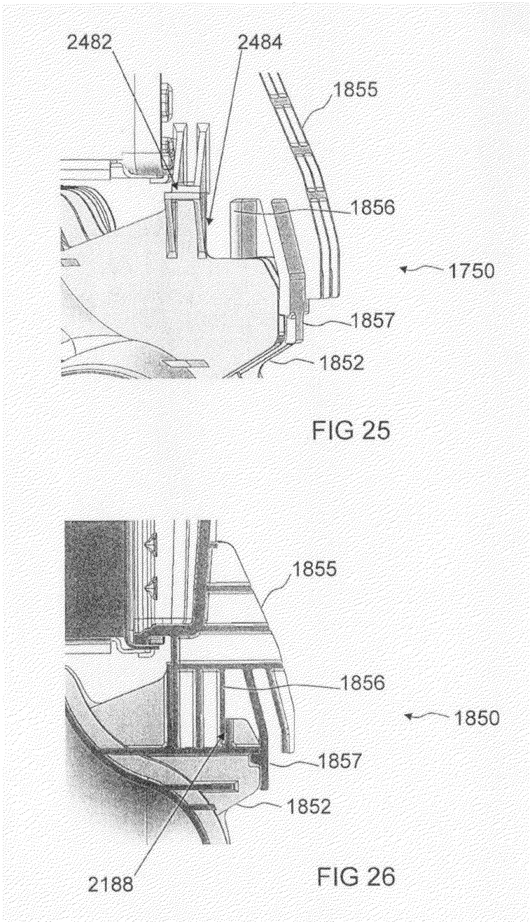

FIG. 28 shows cooling device 1700 illustrated in FIG. 17 according to one exemplary embodiment of the present invention, in the disassembled state. Sliding seat tenon-and-mortise joint 1740 is disengaged.

Only a small amount of installation space is needed for assembly and disassembly. Disassembly may be carried out in the supply air system in the vehicle.

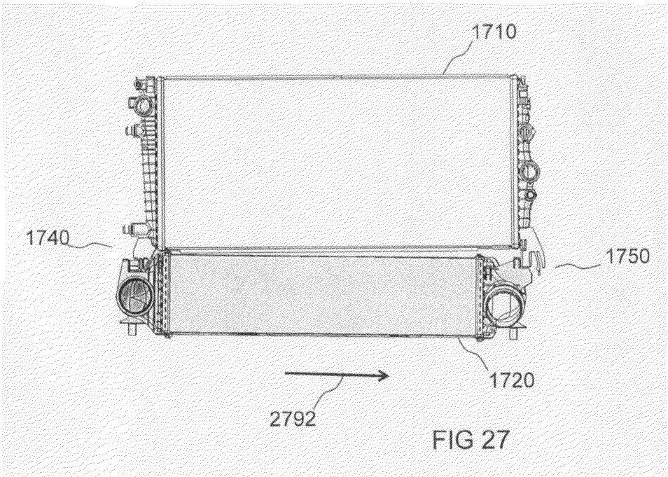

FIG. 29 shows cooling device 1700 illustrated in FIG. 17 according to one exemplary embodiment of the present invention, in the disassembled state. Latching joint 1850 is disengaged.

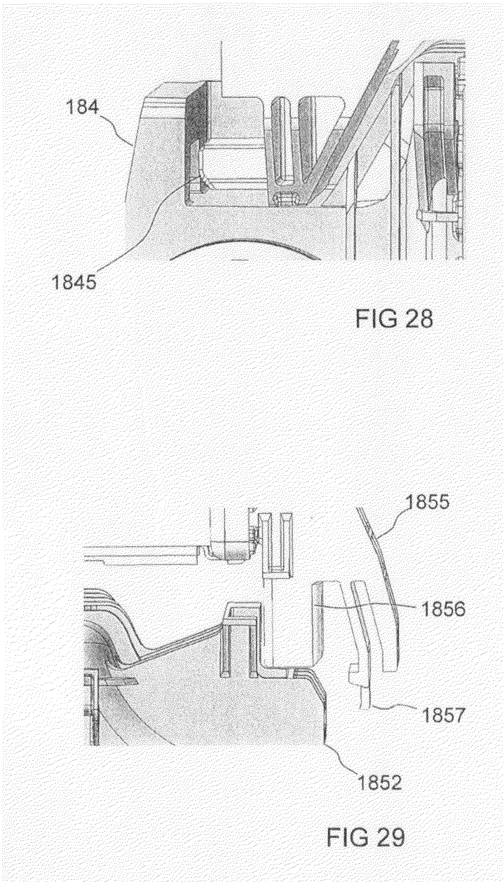

FIG. 30 shows cooling device 1700 illustrated in FIG. 17 according to one exemplary embodiment of the present invention, in the state during assembly or disassembly. Sliding seat tenon-and-mortise joint 1740 is closed but not yet held in place. Contact surface 2468 has already been produced between tenon 1845 and latching hook 1842.

In this position, charge air/air cooler 1720 may be flipped up.

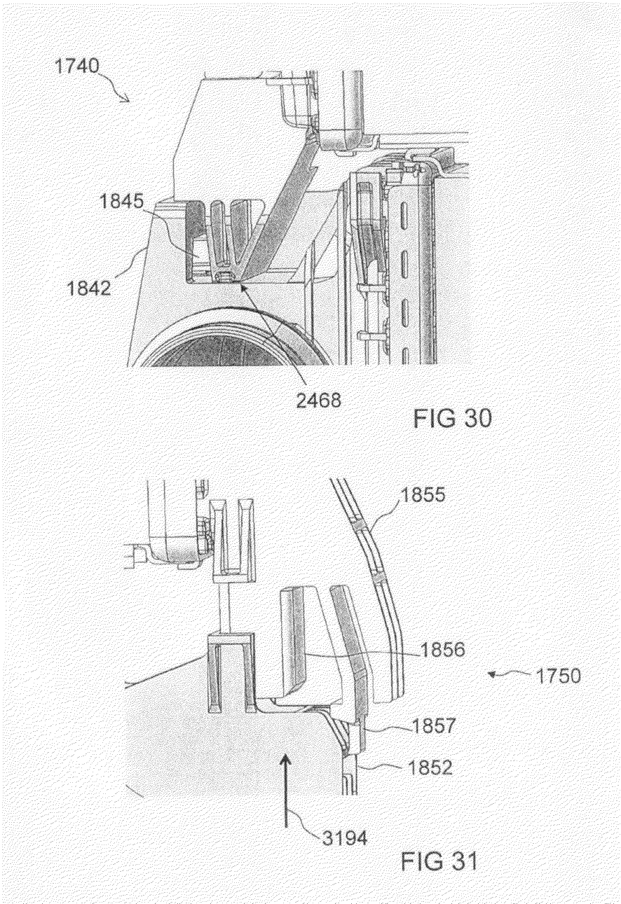

FIG. 31 shows cooling device 1700 illustrated in FIG. 17 according to one exemplary embodiment of the present invention, in the disassembled state. Latching joint 1850 is disengaged. Guide projection 1856 of latching hook 1855 is already in a corresponding receptacle for the guide projection in latching hook receptacle 1852. Latching element 1857 of latching hook 1855 has not yet engaged with latching hook receptacle 1852. The direction of movement of latching joint assembly 3194 is shown from bottom to top in FIG. 31.

In this position, charge air/air cooler 1720 may be flipped up.

The exemplary embodiments described have been selected only by way of example and may be combined with each other.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cooling device for a vehicle, the cooling device comprising:
a first air cooler having a first element of a sliding seat tenon-and-mortise joint and a first element of a latching joint; and
a second air cooler having a second element of the sliding seat tenon-and-mortise joint and a second element of the latching joint, the elements of the latching joint and the elements of the sliding seat tenon-and-mortise joint being configured such that a form-locked connection between the two air coolers is established by the latching joint and the sliding seat tenon-and-mortise joint.

2. The cooling device according to claim 1, wherein one of the elements of the sliding seat tenon-and-mortise joint is a tenon, which has a chamfer on each side, and the other element of the sliding seat tenon-and-mortise joint is designed as a sliding seat for the tenon.

3. The cooling device according to claim 2, wherein at least one of the two air coolers is designed in such a way that a contact surface for holding the tenon in place against the sliding seat is produced in the form-locked connection between the first and second air cooler.

4. The cooling device according to claim 1, wherein one of the elements of the latching joint is a latching hook and the other element of the latching joint is designed as a receptacle for the latching hook.

5. The cooling device according to claim 4, wherein the latching hook is designed to be subjected to either compressive loading or tensile loading in the form-locked connection.

6. The cooling device according to claim 1, wherein the sliding seat tenon-and-mortise joint and the latching hook joint are disposed on two opposite sides of the cooling device.

7. The cooling device according to claim 1, wherein the first air cooler is designed as a coolant/air cooler and the second air cooler is designed as a charge air/air cooler.

8. The cooling device according to claim 1, wherein the two air coolers are made of plastic.

9. The cooling device according to claim 1, wherein the first element of the sliding seat tenon-and-mortise joint and the first element of the latching joint in the first air cooler are permanently integrated, and the second element of the sliding seat tenon-and-mortise joint and the second element of the latching joint in the second air cooler are permanently integrated.

10. A method for manufacturing a cooling device for a vehicle, the method comprising:
providing a first air cooler that has a first element of a sliding seat tenon-and-mortise joint and a first element of a latching joint;
providing a second air cooler that has a second element of the sliding seat tenon-and-mortise joint and a second element of the latching joint, the elements of the latching joint and the elements of the sliding seat tenon-and-mortise joint being designed in such a way that a form-locked connection between the two air coolers is established by the latching joint and the sliding seat tenon-and-mortise joint;
moving the first and second air cooler for the purpose of pushing the two elements of the sliding seat tenon-and-mortise joint into each other at an angle, a rotation axis being produced within the sliding seat tenon-and-mortise joint; and
folding up the first and second air cooler around the rotation axis in the sliding seat tenon-and-mortise joint for the purpose of joining the two elements of the latching joint to form the latching joint in order to establish a form-locked connection between the two air coolers.
